(19) United States
(12) Patent Application Publication
(10) Pub. No.: US 2024/0103540 A1
(43) Pub. Date: Mar. 28, 2024

(54) REMOTE CONTROL DEVICE

(71) Applicant: MITSUBISHI ELECTRIC CORPORATION, Tokyo (JP)

(72) Inventor: Shota KAMEOKA, Tokyo (JP)

(73) Assignee: Mitsubishi Electric Corporation, Tokyo (JP)

(21) Appl. No.: 18/266,808

(22) PCT Filed: Jan. 15, 2021
(86) PCT No.: PCT/JP2021/001340

§ 371 Date: Jun. 13, 2023

(51) Int. Cl. G05D 1/227; G05D 1/622; G05D 1/692; G05D 1/695; G05D 109/10; G05D 111/30

(52) U.S. Cl. CPC G05D 1/2274; G05D 1/622; G05D 1/692; G05D 1/695; G05D 2109/10; G05D 2111/32

(57) ABSTRACT

A remote control device is a remote control device configured to control one or more mobile objects via a network, which includes a receiver configured to receive mobile object information including a first state quantity of a state quantity of the mobile object and surrounding information around the mobile object, a trajectory generation unit configured to generate a target trajectory of the mobile object on the basis of the surrounding information, a mobile object estimation unit configured to estimate transmission latency of the network, a gain setting unit configured to set a control gain on the basis of the transmission latency, a control amount calculation unit configured to calculate a control amount for causing the mobile object to follow the target trajectory on the basis of the mobile object information and the control gain, and a transmitter configured to transmit the control amount to the mobile object.

### TECHNICAL FIELD

The present disclosure relates to a remote control device for controlling one or more mobile objects via a network.

### BACKGROUND ART

In recent years, progress has been made in the development of remote control devices that implement autonomous operation such as autonomous valet parking and autonomous transportation by transmitting/receiving data to and from a mobile object located at a remote location. A network constructed by wireless communication is used for data transmission/reception. In a case where the network is adopted, the distance between the remote control device and the mobile object, obstacles therebetween, and the like, cause transmission latency in transmitting/receiving data. If the control of the mobile object is to be made under such an environment, the mobile object may fall into an unstable state.

Patent Document 1 discloses a travel control method and a travel control device for autonomously operated vehicles in which the effect of transmission latency is to be reduced by controlling a plurality of vehicles in focus.

### PRIOR ART DOCUMENTS

### Patent Document(s)

[Patent Document 1] Japanese Patent Application Laid-Open No. 2019-46013 NON-PATENT DOCUMENT(S)
[Non-Patent Document 1] “Control of Systems with Stochastic Parameters”, Instrument and Control Engineers Publishing, Vol. 59, No. 3, 2020, pp. 212 to 217
[Non-Patent Document 2] Yohei Hosoe et al. “Equivalent Stability Notions, Lyapunov Inequality, and Its Application in Discrete-Time Linear Systems with Stochastic Dynamics Determined by an i.i.d. Process” IEEE Trans. Automatic Control, 2018
[Non-Patent Document 3] “Aperiodic Control of Networked Systems with Communication Delays Represented with Exponential Distributions”, 63rd Joint Automatic Control Conference Publishing, 2020, pp. 488 to 492

### SUMMARY

### Problem to be Solved by the Invention

In Patent Document 1, traveling priorities are determined for a plurality of vehicles determined to have entered an intersection, and the vehicles are controlled on the basis of the traveling priorities. However, due to the traveling priorities being determined after entering the intersection, a vehicle with a low traveling priority is requested to stop immediately. For this reason, smooth traveling of the vehicles may fail to implement.

The present disclosure has been made to solve the above-described problem, and an object of the present disclosure is to provide a remote control device that implements smooth traveling of a mobile object.

### Means to Solve the Problem

According to the present disclosure, a remote control device configured to control one or more mobile objects via a network, includes a receiver configured to receive mobile object information including a first state quantity of a state quantity of the mobile object and surrounding information regarding the surrounding of the mobile object, a trajectory generation unit configured to generate a target trajectory of the mobile object on the basis of the surrounding information, a mobile object estimation unit configured to estimate transmission latency of the network, a gain setting unit configured to set a control gain on the basis of the transmission latency, a control amount calculation unit configured to calculate a control amount for causing the mobile object to follow the target trajectory on the basis of the mobile object information and the control gain, and a transmitter configured to transmit the control amount to the mobile object.

### Effects of the Invention

According to the present disclosure, smooth traveling can be implemented since the remote control device generates the target trajectory of the mobile object on the basis of the surrounding information around the mobile object, and controls the mobile object to follow the target trajectory.

### BRIEF DESCRIPTION OF DRAWINGS

FIG. 1 A block diagram illustrating an example of a configuration of a remote control device when controlling one mobile object in an embodiment of the present disclosure.

FIG. 2 A block diagram illustrating an example of a configuration of the remote control device when controlling two or more mobile objects in the embodiment of the present disclosure.

FIG. 3 A block diagram illustrating an example of a configuration of a first mobile object control calculation unit according to the embodiment of the present disclosure.

FIG. 4 A block diagram illustrating another example of a configuration of the first mobile object control calculation unit according to the embodiment of the present disclosure.

FIG. 5 A block diagram illustrating another example of a configuration of a first mobile object according to the embodiment of the present disclosure.

FIG. 6 A diagram illustrating an example of a configuration in which the mobile object is a vehicle in the embodiment of the present disclosure.

FIG. 7 A diagram illustrating an example of a target trajectory generation method according to the embodiment of the present disclosure.

FIG. 8 A diagram illustrating another example of the target trajectory generation method according to the embodiment of the present disclosure.

FIG. 9 A diagram illustrating an example of a target trajectory generation method for two or more mobile objects according to the embodiment of the present disclosure.

FIG. 10 A diagram illustrating another example of the target trajectory generation method for two or more mobile objects according to the embodiment of the present disclosure.

FIG. 11 A block diagram illustrating an example of a configuration in which of the remote control device controls the mobile object in the embodiment of the present disclosure.

FIG. 12 A schematic diagram illustrating an example of a vehicle model according to the embodiment of the present disclosure.

FIG. 13 A flowchart illustrating an example of a procedure for remote control according to the embodiment of the present disclosure.

FIG. 14 A diagram illustrating a hardware configuration of the remote control device according to the embodiment of the present disclosure.

### DESCRIPTION OF EMBODIMENT(S)

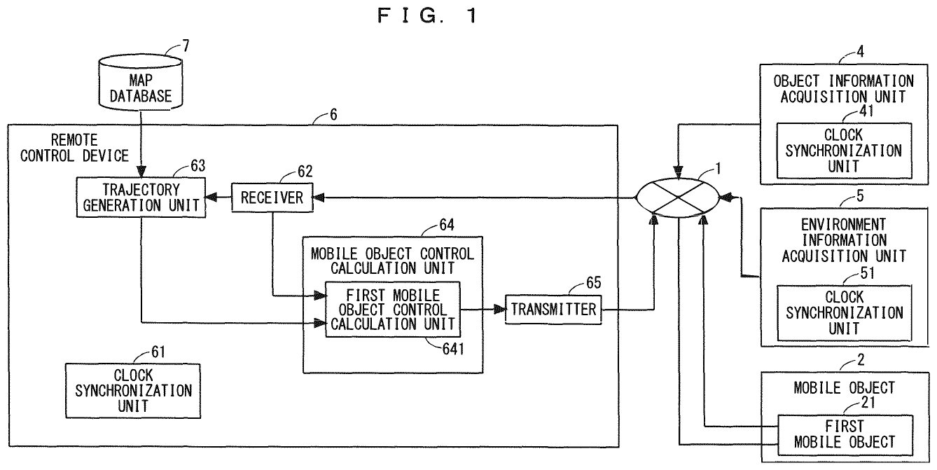

FIG. 1 is a block diagram illustrating an example of a configuration of a remote control device 6 when controlling one mobile object 2 in the present embodiment. FIG. 1 is a block diagram illustrating a configuration including a network 1, a mobile object 2, an object information acquisition unit 4, an environment information acquisition unit 5, a remote control device 6, and a map database 7. FIG. 1 is a block diagram of the remote control device 6 that controls one mobile object 2 (first mobile object 21) via a network 1.

The network 1 is capable of transmitting/receiving data with a plurality of components being mutually connected with cables, radio waves, and the like. The network includes various methods such as a local area network (LAN), a wide area network (WAN), Internet, telephone lines, and wireless communication. In the present disclosure, the network is not limited thereto, and any medium can be adoptable as long as data can be transmitted/received between the remote control device 6 and the mobile object 2 located at a remote location.

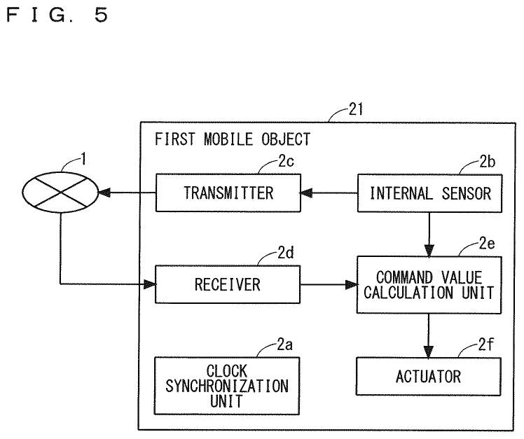

The mobile object 2 is the first mobile object 21. The first mobile object 21 travels on the basis of the control amount from a transmitter 65 of the remote control device 6. The configuration of the first mobile object 21 will be described later in detail with reference to FIG. 5.

The object information acquisition unit 4 is configured with one or more sensors installed around the mobile object 2. The object information acquisition unit 4 acquires the positions and speeds of obstacles such as other vehicles, bicycles, and pedestrians around the mobile object 2 as surrounding information. Also, the object information acquisition unit 4 can acquire the position and speed of the mobile object 2 per se as mobile object information. When the mobile object 2 is provided with an internal sensor 2b, the mobile object information can also be obtained from the internal sensor 2b. The object information acquisition unit 4 transmits the mobile object information and the surrounding information to the receiver 62 in the remote control device 6 via the network 1. It should be noted that the object information acquisition unit 4 includes a clock synchronization unit 41. The clock synchronization unit 41 has a function to synchronize the timing of data transmission/reception in cooperation with a clock synchronization unit 2a in the mobile object 2, a clock synchronization unit 51 in the environment information acquisition unit 5, and a clock synchronization unit 61 in the remote control device 6.

As with the object information acquisition unit 4, the environment information acquisition unit 5 is configured with one or more sensors installed at a remote location. The environment information acquisition unit 5 acquires environment information such as traffic lights and stop lines. The environment information acquisition unit 5 transmits the environment information to the receiver 62 in the remote control device 6 via the network 1. The environment information may be included in the surrounding information acquired by the object information acquisition unit 4. Hereinafter, the environmental information is assumed to be included in the surrounding information, and the surrounding information is to be used as a unified term thereof. Also, the sensor used in the environment information acquisition unit 5 may be installed on the mobile object 2 per se. It should be noted that the environment information acquisition unit 5 includes the clock synchronization unit 51. The clock synchronization unit 51 has a function to synchronize the timing of data transmission/reception in cooperation with the clock synchronization unit 2a, a clock synchronization unit 41, and a clock synchronization unit 61.

The sensors used in the object information acquisition unit 4 and the environment information acquisition unit 5 are, for example, cameras, Light Detection and Ranging (LiDAR), and radar.

The camera acquires surrounding images and outputs the images as image data.

LiDAR detects the positions of objects by irradiating laser beams to the surrounding area and detecting the time difference of the laser beams reflecting off a surrounding object and coming back.

The radar measures the relative distance and relative speed of obstacles existing in the surroundings with respect to the radar by irradiating toward the surroundings and detecting the reflected waves thereof, and outputs the measurement results.

In a case where the Global Navigation Satellite System (GNSS) sensor, which detects the absolute positions of obstacles and the like around mobile object 2, is installed on obstacles such as the mobile object 2 or other vehicles, and the GNSS sensor can transmit absolute position information to the remote control device 6 via the network 1, the object information acquisition unit 4 is unnecessary since object information can be detected by the GNSS sensor.

The map database 7 stores map data around the mobile object 2. Although the trajectory generation unit 63 is connected to the map database 7 in FIG. 1, not only the trajectory generation unit 63 but also each component in the remote control device 6 can access the map database 7. When the mobile object 2 is a vehicle, the map database 7 includes data related to traveling in many cases such as road center coordinate information, stop line information, white line information, and traveling possible areas. The remote control device 6 includes the clock synchronization unit 61, the receiver 62, the trajectory generation unit 63, a mobile object control calculation unit 64, and the transmitter 65.

The clock synchronization unit 61 has a function to synchronize the timing of data transmission/reception in cooperation with the clock synchronization unit 2a, a clock synchronization unit 41, and a clock synchronization unit 51.

The receiver 62 receives the mobile object information and the surrounding information from the object information acquisition unit 4, the surrounding information from the environment information acquisition unit 5, and the mobile object information from the mobile object 2. The mobile object information is composed of a first state quantity such as the position and speed of the mobile object 2. That is, the first state quantity represents the state quantity acquired by the sensor. The receiver 62 receives the mobile object information including the first state quantity of the state quantity of the mobile object 2 and the surrounding information around the mobile object 2.

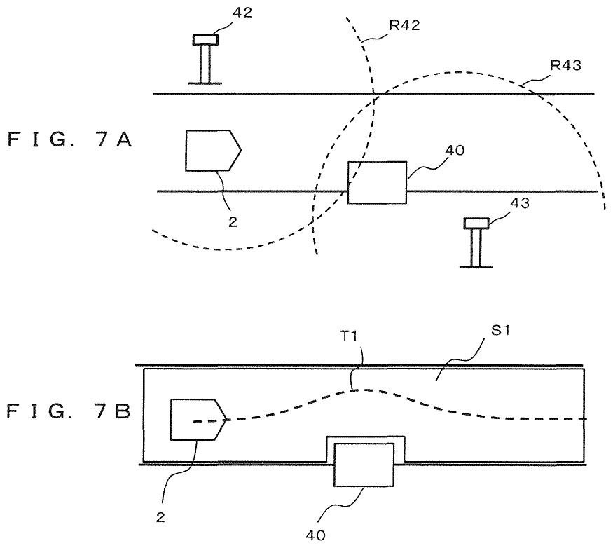

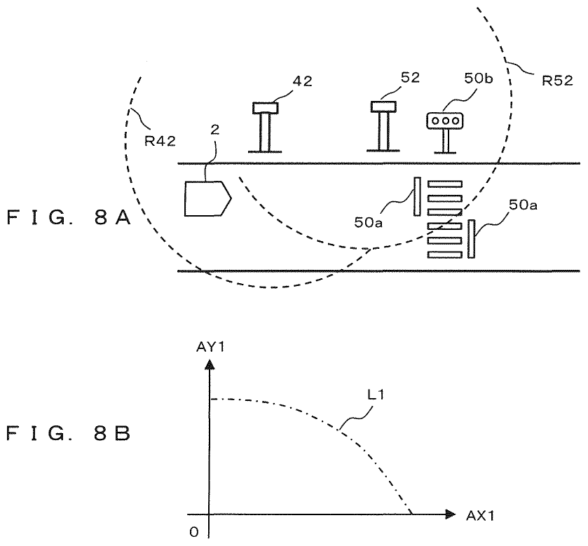

The trajectory generation unit 63 generates a target trajectory of the mobile object 2 on the basis of the map data from the map database 7 and the surrounding information from the receiver 62. Here, the target trajectory is a combination of a target route and a target speed. Alternatively, the target trajectory may be, for example, a combination of a target route and a target position. Also, the target trajectory is not limited to the target speed or the target position, and any may be adoptable as long as it is a state quantity of the mobile object 2. Note that the trajectory generation unit 63 may generate the target trajectory of the mobile object 2 on the basis of the surrounding information alone. The method by which the trajectory generation unit 63 generates the target trajectory will be described later in detail with reference to FIGS. 7 and 8.

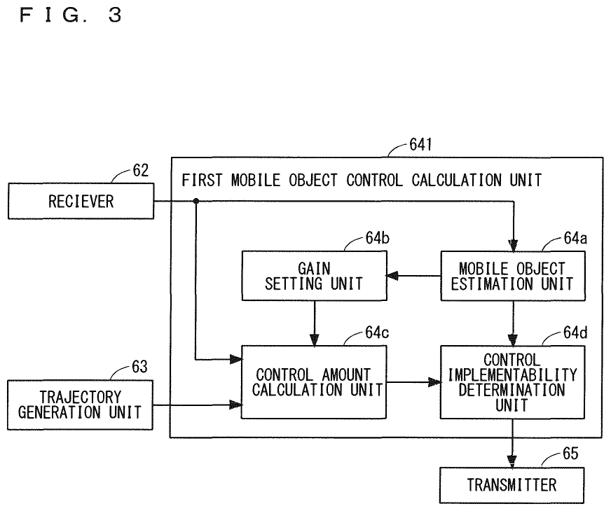

The mobile object control calculation unit 64 includes a first mobile object control calculation unit 641. On the basis of the mobile object information from the receiver 62 and the target trajectory from the trajectory generation unit 63, the first mobile object control calculation unit 641 calculates a control amount for causing the first mobile object 21 to follow the target trajectory. When the mobile object 2 is a vehicle, the control amount is, for example, a target steering amount and a target acceleration/deceleration amount. The first mobile object control calculation unit 641 will be described later in detail with reference to FIG. 3.

The transmitter 65 transmits the control amount from the first mobile object control calculation unit 641 to the first mobile object 21 via the network 1.

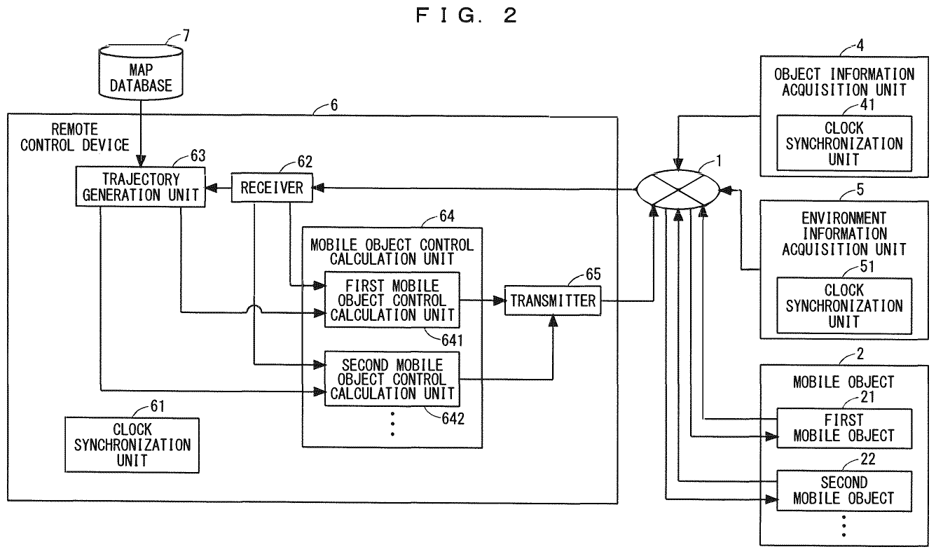

FIG. 2 is a block diagram illustrating an example of a configuration of the remote control device 6 when controlling two or more mobile objects 2 in the present embodiment. FIG. 2 is different from FIG. 1 in terms of the mobile object 2 being the first mobile object 21, the second mobile object 22, and the like, and the mobile object control calculation unit 64 including the first mobile object control calculation unit 641 and the second mobile object control calculation unit 642 and the like. The description is omitted since the configuration is the same as FIG. 1 except for these elements.

The receiver 62 receives the mobile object information and the surrounding information from the object information acquisition unit 4, the surrounding information from the environment information acquisition unit 5, and the mobile object information from the respective mobile objects 2

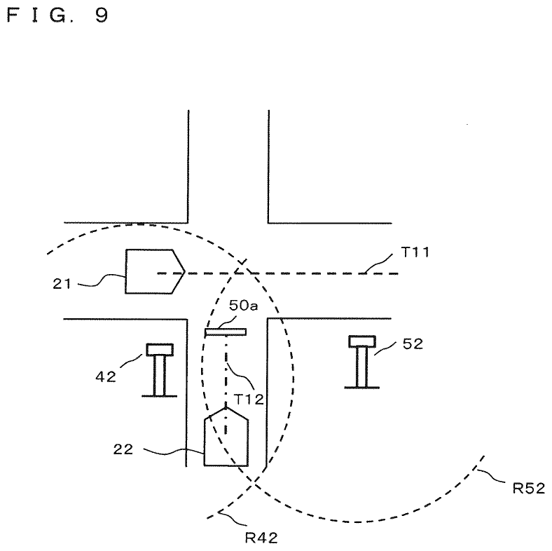

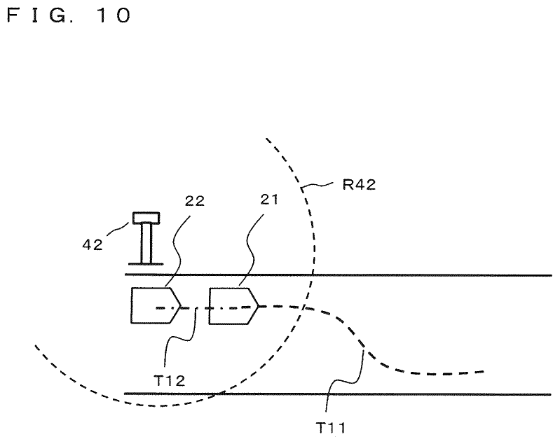

The trajectory generation unit 63 generates each target trajectory for two or more mobile objects 2 on the basis of the map data from the map database 7 and the surrounding information from the receiver 62. The method by which the trajectory generation unit 63 generates each target trajectory for two or more mobile objects 2 will be described later in detail with reference to FIGS. 9 and 10.

Of the mobile object control calculation unit 64, the first mobile object control calculation unit 641 calculates a control amount for the first mobile object 21 on the basis of the mobile object information of the first mobile object 21 and the target trajectory of the first mobile object 21. Similarly, the second mobile object control calculation unit 642 calculates a control amount for the second mobile object 22 on the basis of the mobile object information of the second mobile object 22 and the target trajectory of the second mobile object 22. In a case where the number of mobile objects 2 is three or more, the mobile object control calculation unit 64 additionally includes a third mobile object control calculation unit or the like in accordance with an increase in the number of mobile objects 2.

The transmitter 65 transmits the control amount from the first mobile object control calculation unit 641 and the control amount from the second mobile object control calculation unit 642 and the like to the mobile objects 2 via the network 1. The control amount from the first mobile object control calculation unit 641 is transmitted to the first mobile object 21. Similarly, the control amount from the second mobile object control calculation unit 642 is transmitted to the second mobile object 22.

FIG. 3 is a block diagram illustrating an example of a configuration of the first mobile object control calculation unit 641 according to the present embodiment. The first mobile object control calculation unit 641 includes a mobile object estimation unit 64a, a gain setting unit 64b, a control amount calculation unit 64c, and a control implementability determination unit 64d. In the case where the remote control device 6 remotely controls two or more mobile objects 2, the second mobile object control calculation unit 642 and the like similarly includes a mobile object estimation unit 64a, a gain setting unit 64b, a control amount calculation unit 64c, and a control implementability determination unit 64d.

The mobile object estimation unit 64a estimates the transmission latency of the network 1. However, the mobile object estimation unit 64a may estimate the distribution of the transmission latency of the network 1 since the transmission latency of the network 1 can fluctuate. The distribution indicates, for example, a probability distribution, however, it is not limited to a probability distribution. The mobile object estimation unit 64a may estimate the distribution of the transmission latency on the basis of the transmission latency previously acquired before the remote control device 6 remotely controls the mobile object 2, or may estimate the distribution of the transmission latency online while remotely controlling the mobile object 2. Further, the mobile object estimation unit 64a may estimate the distribution of coefficients for the state quantity of the mobile object 2 on the basis of the mobile object information from the receiver 62. The coefficients are the mass of the mobile object 2 and the moment of inertia. In particular, when the mobile object 2 is a vehicle, cornering stiffness and the like are also included. As with the transmission latency of the network 1, these coefficients also affect control stability and can fluctuate. The coefficients are estimated on the basis of a state equation and the state quantity regarding to the mobile object 2.

The gain setting unit 64b sets a control gain on the basis of the transmission latency of the network 1. Alternatively, the gain setting unit 64b sets the control gain on the basis of the distribution of the transmission latency. Alternatively, the gain setting unit 64b sets the control gain on the basis of the distribution of the transmission latency and the distribution of the coefficients for the state quantity of the mobile object 2. If the transmission latency of the network 1 is simply set to a fixed value, or if it is set to an assumed maximum value, the control to be executed would be conservative since the gain setting unit 64b sets the control gain in consideration of the transmission latency with a low probability of occurrence. On the other hand, when the distribution of the transmission latency of the network 1 is adopted, the following performance of the mobile object 2 to the target trajectory can be improved since the gain setting unit 64b sets the control gain in consideration of the occurrence probability of the transmission latency.

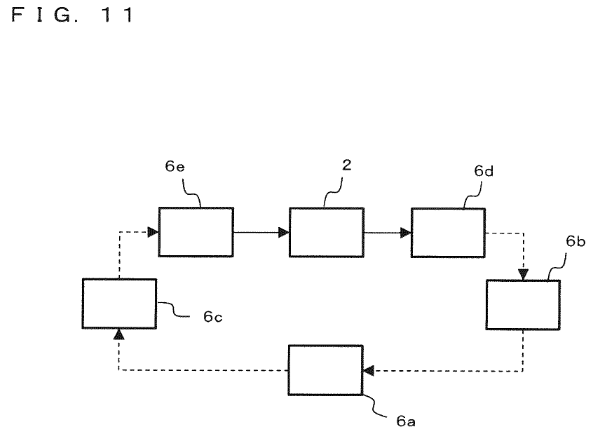

The control amount calculation unit 64c calculates a control amount for causing the mobile object 2 to follow the target trajectory on the basis of the mobile object information from the receiver 62 and the control gain. A method of setting the control gain by the gain setting unit 64b and a method of calculating the control amount by the control amount calculation unit 64c will be described later in detail with reference to FIG. 11 and Non-Patent Documents 1 to 3.

The control implementability determination unit 64d determines continuation of control or suspension of control of the mobile object 2 on the basis of the transmission latency of the network 1. Alternatively, the control implementability determination unit 64d determines continuation of control or suspension of control of the mobile object 2 on the basis of the distribution of the transmission latency. Alternatively, the control implementability determination unit 64d determines continuation of control or suspension of control of the mobile object 2 on the basis of the distribution of the transmission latency and the distribution of the coefficients for the state quantity of the mobile object 2. The control implementability determination unit 64d outputs the control amount for controlling the mobile object 2, that is, the control amount from the control amount calculation unit 64c, to the transmitter 65 when the determination result is continuation of control. When the determination result is suspension of control, the control implementability determination unit 64d sets a value that causes the mobile object 2 to stop as the control amount, and outputs the control amount to the transmitter 65. A method of determining continuation of control or suspension of control will be described later in detail.

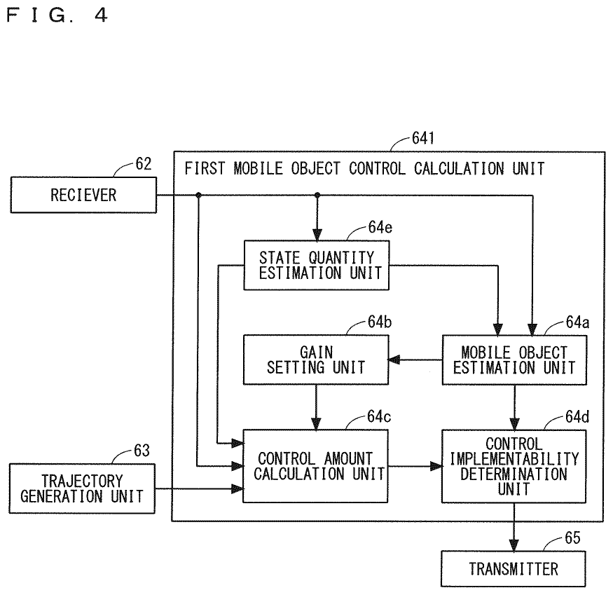

FIG. 4 is a block diagram illustrating another example of a configuration of the first mobile object control calculation unit 641 according to the present embodiment. The first mobile object control calculation unit 641 includes the mobile object estimation unit 64a, the gain setting unit 64b, the control amount calculation unit 64c, the control implementability determination unit 64d, and a state quantity estimation unit 64e. FIG. 4 differs from FIG. 3 in that the first mobile object control calculation unit 641 includes the state quantity estimation unit 64e. In the case where the remote control device 6 remotely controls two or more mobile objects 2, the second mobile object control calculation unit 642 and the like similarly includes the mobile object estimation unit 64a, the gain setting unit 64b, the control amount calculation unit 64c, the control implementability determination unit 64d, and the state quantity estimation unit 64e. The description is omitted since the configuration is the same as FIG. 3 except for the state quantity estimation unit 64e.

The state quantity estimation unit 64e estimates a second state quantity different from the first state quantity of the state quantity of the mobile object 2 on the basis of the mobile object information from the receiver 62. The second state quantity represents the state quantity not acquired by the sensor. The state quantity estimation unit 64e estimates the second state quantity by applying an observer, a Kalman filter, or the like, on the basis of the state equation and the mobile object information regarding the mobile object 2. The remote control device 6 controls the mobile object 2 using the second state quantity that as well which is not acquired by the sensor, leading to the remote control of the mobile object 2 with higher accuracy.

When estimating the distribution of coefficients for the state quantity of the mobile object 2, the mobile object estimation unit 64a may use not only the mobile object information from the receiver 62 but also the second state quantity from the state quantity estimation unit 64e.

The control amount calculation unit 64c calculates a control amount on the basis of the mobile object information from the receiver 62, the second state quantity from the mobile object estimation unit 64a, and the control gain from the gain setting unit 64b.

FIG. 5 is a block diagram illustrating an example of a configuration of the first mobile object 21 according to the present embodiment. The first mobile object 21 includes a clock synchronization unit 2a, an internal sensor 2b, a transmitter 2c, a receiver 2d, a command value calculation unit 2e, and an actuator 2f. In the case where the remote control device 6 remotely controls two or more mobile objects 2, the second mobile object 22 and the like similarly include the clock synchronization unit 2a, the internal sensor 2b, the transmitter 2c, the receiver 2d, the command value calculation unit 2e, and the actuator 2f.

The clock synchronization unit 2a synchronizes the timing of data transmission/reception in cooperation with the clock synchronization unit 41, the clock synchronization unit 51, and the clock synchronization unit 61.

The internal sensor 2b is installed on the mobile object 2 and outputs the mobile object information. When the mobile object 2 is a vehicle, the internal sensor 2b is, for example, a vehicle speed sensor 21b, an Inertial Measurement Unit (IMU) sensor 22b, a steering angle sensor 23b, a steering torque sensor 24b, and the like.

The transmitter 2c transmits the mobile object information from the internal sensor 2b to the receiver 62 of the remote control device 6 via the network 1.

The receiver 2d receives the control amount from the transmitter 65 of the remote control device 6.

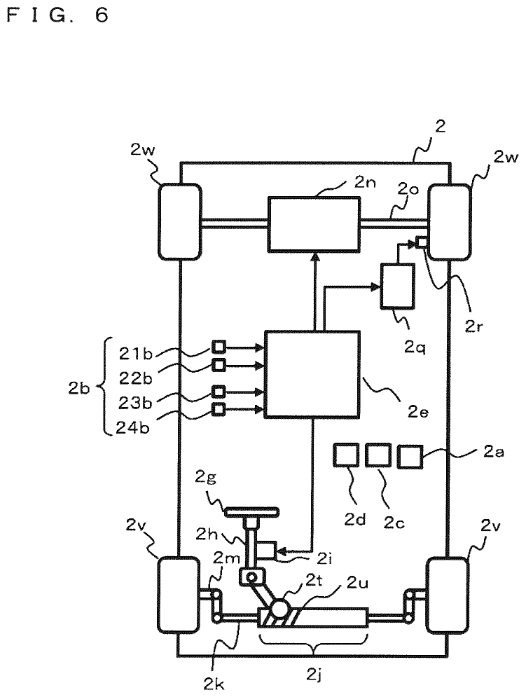

The command value calculation unit 2e converts the control amount into a current value or the like on the basis of the mobile object information from the internal sensor 2b and the control amount from the receiver 2d, and outputs the current value to the actuator 2f. When the mobile object 2 is a vehicle, the actuator 2f is an electric motor 2i, a vehicle drive device 2n, a brake control device 2q, and the like. In this case, the command value calculation unit 2e calculates the current value to be supplied to the electric motor 2i in order to cause a steering of the vehicle to follow the target steering amount, and outputs the calculation result to the electric motor 2i. Also, the command value calculation unit 2e calculates a driving force and a braking force of the vehicle required for causing the acceleration of the vehicle to follow a target acceleration/deceleration amount, and outputs the calculation result to the vehicle drive device 2n and the brake control device 2q. The electric motor 2i, the vehicle drive device 2n and the brake control device 2q will be described later in detail with reference to FIG. 6.

The mobile object 2 is, for example, a vehicle, a flight vehicle, an agricultural machine, or the like. FIG. 6 is a diagram illustrating an example of a configuration in which the mobile object 2 is a vehicle in the present embodiment.

A steering wheel 2g, which is installed for a driver (i.e., operator) to operate the vehicle, is coupled to a steering shaft 2h. A pinion shaft 2t of a rack-and-pinion mechanism 2j is connected to the steering shaft 2h. A rack shaft 2u of the rack-and-pinion mechanism 2j is reciprocally movable in response to the rotation of the pinion shaft 2t, and front knuckles 2m are connected to both left and right ends thereof via tie rods 2k. The front knuckles 2m rotatably support front wheels 2v as steering wheels, and are steerably supported to the vehicle body frame.

The torque generated by the driver operating the steering wheel 2g rotates the steering shaft 2h, and the rack-and-pinion mechanism 2j moves the rack shaft 2u in the left-right direction in response to the rotation of the steering shaft 2h. The movement of the rack shaft 2u causes the front knuckles 2m to rotate around kingpin shafts (not illustrated), thereby causing the front wheels 2v to turn in the left-right direction. Therefore, the driver can change an amount of lateral movement of the vehicle by operating the steering wheel 2g when the vehicle moves forward or backward.

The vehicle is provided with the vehicle speed sensor 21b, the IMU sensor 22b, the steering angle sensor 23b, a steering torque sensor 24b, and the like, as the internal sensor 2b for acknowledging the traveling state of the vehicle.

The vehicle is also provided with actuators such as the electric motor 2i for implementing lateral motion of the vehicle, the vehicle drive device 2n for controlling longitudinal motion of the vehicle, and the brake control device 2q.

Typically, the electric motor 2i is configured by a motor and a gear, and is capable of freely rotating the steering shaft 2h by applying torque to the steering shaft 2h. In other words, the electric motor 2i can freely steer the front wheels 2v independently of the operation of the steering wheel 2g by the driver.

The vehicle drive device 2n is an actuator 2f for driving the vehicle in the longitudinal direction. The vehicle drive device 2n rotates the front wheels 2v and rear wheels 2w with driving force obtained from a driving source such as an engine or a motor via a transmission (not illustrated) and a shaft 2o. Accordingly, the vehicle drive device 2n can freely control the driving force of the vehicle.

Meanwhile, the brake control device 2q is an actuator 2f for braking the vehicle, and controls the brake amounts of the brakes 2r installed on the front wheels 2v and the rear wheels 2w of the vehicle. A typical brake 2r generates a braking force using hydraulic pressure to press a pad against a disk rotor that rotates together with the front wheels 2v and the rear wheels 2w.

It is assumed that the internal sensor 2b and the plurality of devices described above comprise a network using a Controller Area Network (CAN), a Local Area Network (LAN), or the like in the vehicle. The devices can obtain the respective information via the network 1. In addition, the internal sensor 2b is capable of mutually transmitting and receiving data via the network 1.

The configuration when the mobile object 2 is a vehicle has been described with reference to FIG. 6, and the configuration is the same when the mobile object 2 is other than a vehicle.

The method by which the trajectory generation unit 63 generates the target trajectory will be described with reference to FIGS. 7 and 8. FIG. 7(a) and FIG. 7(b) are diagrams illustrating an example of a target trajectory generation method according to the present embodiment. FIG. 7(a) is a schematic diagram illustrating a case where an obstacle 40 exists in front of the mobile object 2 while traveling. FIG. 7(b) is a diagram illustrating a case where the target route T1 for generating a target trajectory of the mobile object 2 when the obstacle 40 exists ahead. FIG. 8(a) and FIG. 8(b) are diagrams illustrating an example of another target trajectory generation method according to the present embodiment. FIG. 8(a) is a schematic diagram illustrating a case where a stop line 50a and a traffic light 50b exist in front of the mobile object 2 while traveling. FIG. 8(b) is a diagram illustrating the target speed AY1 for generating a target trajectory of the mobile object 2 when the stop line 50a and the traffic light 50b exist ahead. In FIG. 8(b), the horizontal axis represents the traveling distance AX1 when the mobile object 2 travels toward the stop line 50a, and the vertical axis represents the target speed AY1.

As illustrated in FIG. 7(a), it is assumed that a plurality of sensors (here, sensors 42 and 43 in the object information acquisition unit 4) are installed around the mobile object 2, and detection ranges of the respective sensors are represented by R42 and R43. The sensor 42 detects the relative position and the relative speed of the mobile object 2 with respect to the sensor 42, and the sensor 43 detects the relative position and the relative speed of the obstacle 40 with respect to the sensor 43. The trajectory generation unit 63 generates the target route T1 as illustrated in FIG. 7(b) on the basis of these pieces of information. The target route T1 is a route for the mobile object 2 to avoid the obstacle 40 and is a route for traveling within a travelable area S1. Although not illustrated here, the trajectory generation unit 63 also generates a target speed of the mobile object 2. As an example, the trajectory generation unit 63 generates a target speed so that the mobile object 2 slows down when avoiding the obstacle 40. The trajectory generation unit 63 generates a target trajectory (avoidance trajectory) in which the target route T1 and the target speed are combined.

As illustrated in FIG. 8(a), it is assumed that a plurality of sensors (here, the sensor 42 in the object information acquisition unit 4 and a sensor 52 in the environment information acquisition unit 5) are installed around the mobile object 2, and detection ranges of the respective sensors are represented by R42 and R52. The sensor 42 detects the relative position and the relative speed of the mobile object 2 with respect to the sensor 42, and the sensor 52 detects the relative position of the stop line 50a and the traffic light 50b with respect to the sensor 52. Also, it is assumed that the sensor 52 detects that the traffic light 50b is red. The trajectory generation unit 63 generates the target route (not illustrated) on the basis of these pieces of information. The target route is a route along which the mobile object 2 travels straight toward the stop line 50a. Further, as illustrated in FIG. 8(b), the trajectory generation unit 63 generates the target speed so that the target speed AY1 of the mobile object 2 is to be the one-dot chain line L1. The target speed AY1 is a speed in which the speed of the mobile object 2 is gradually decelerated to zero at the stop line 50a. The trajectory generation unit 63 generates a target trajectory (stopping trajectory) in which the target route and the target speed AY1 are combined.

As illustrated in FIGS. 7 and 8, the target trajectory is an avoidance trajectory with respect to the obstacle 40 and a stopping trajectory until the mobile object 2 stops. The target trajectory is not limited to these two trajectories, and there are various types thereof according to the road on which the mobile object 2 travels. In this manner, the trajectory generation unit 63 generates the target trajectory for the mobile object 2, so that early-stage monitoring as to whether the mobile object 2 is traveling along the target trajectory is ensured, thereby implementing smooth traveling of the mobile object 2. Although it is conceivable that the mobile object 2 per se generates the target trajectory, it is preferable that the trajectory generation unit 63 generates the target trajectory in terms of making the mobile object 2 versatile. This also brings the effect of simplifying the configuration of the mobile object 2. In FIGS. 7 and 8, although one mobile object 2 is illustrated, even if there are two or more mobile objects 2, the respective target trajectories are generated by the same method.

Next, the method by which the trajectory generation unit 63 generates target trajectories for the respective two or more mobile objects 2 will be described with reference to FIGS. 9 and 10. FIG. 9 is a diagram illustrating an example of a target trajectory generation method for two or more mobile objects 2 according to the present embodiment. FIG. 10 is a diagram illustrating an example of another target trajectory generation method for two or more mobile objects 2 according to the present embodiment.

FIG. 9 is a diagram illustrating the target trajectory generation method when the mobile objects 2 (here, a first mobile object 21 and a second mobile object 22) travel through an intersection. It is assumed that a plurality of sensors (here, the sensor 42 in the object information acquisition unit 4 and the sensor 52 in the environment information acquisition unit 5) are installed around the mobile objects 2, and detection ranges of the respective sensors are represented by R42 and R52. The sensor 42 detects the relative positions and the relative speeds of the first mobile object 21 and the second mobile object 22 with respect to the sensor 42, and the sensor 52 detects the relative position of the stop line 50a with respect to the sensor 52. The trajectory generation unit 63 generates the target route T11 for the first mobile object 21 on the basis of these pieces of information. Although not illustrated here, the trajectory generation unit 63 also generates the target speed of the first mobile object 21. The trajectory generation unit 63 generates the target speed such that the first mobile object 21 has a constant speed along the target route T11. Also, the trajectory generation unit 63 generates a target route T12 for the second mobile object 22. Although not illustrated here, the trajectory generation unit 63 also generates the target speed of the second mobile object 22. The target speed for the second mobile object 22 is a speed that is gradually decelerated as it approaches the stop line 50a and reaches zero at the stop line 50a. The trajectory generation unit 63 generates a target trajectory in which the target route T11 and the target speed for the first mobile object 21 are combined. Similarly, the trajectory generation unit 63 generates a target trajectory in which the target route T12 and the target speed for the second mobile object 22 are combined.

In FIG. 9, the trajectory generation unit 63 generates a target trajectory in which travel priorities of the mobile objects 2 are considered. In this case, the target trajectories for the first mobile object 21 and the second mobile object 22 are generated such that the first mobile object 21 has a higher traveling priority from the stop line 50a to be detected by the sensor 52.

FIG. 10 is a diagram illustrating the target trajectory generation method when the mobile objects 2 (here, the first mobile object 21 and the second mobile object 22) travel in column formation. It is assumed that a sensor (here, the sensor 42 in the object information acquisition unit 4) is installed around the mobile objects 2, and a detection range of the sensor 42 is represented by R42. The sensor 42 detects the relative positions and the relative speeds of the first mobile object 21 and the second mobile object 22 with respect to the sensor 42. The trajectory generation unit 63 generates the target route T11 of the first mobile object 21 on the basis of these pieces of information. Although not illustrated here, the trajectory generation unit 63 also generates the target speed of the first mobile object 21. As an example, the trajectory generation unit 63 generates the target speed such that the first mobile object 21 has a constant speed along the target route T11. Also, the trajectory generation unit 63 generates the target route T12 for the second mobile object 22. Although not illustrated here, the trajectory generation unit 63 also generates the target speed of the second mobile object 22. The target speed for the second mobile object 22 is the same as the target speed for the first mobile object 21. The trajectory generation unit 63 generates a target trajectory in which the target route T11 and the target speed for the first mobile object 21 are combined. Similarly, the trajectory generation unit 63 generates a target trajectory in which the target route T12 and the target speed for the second mobile object 22 are combined.

In FIG. 10, the trajectory generation unit 63 generates a target trajectory in which, with respect to the first mobile object 21, which is a leader of the mobile objects 2, the second mobile object 22 other than the leader forms a column.

As described with reference to FIGS. 9 and 10, the trajectory generation unit 63 generates the target trajectory for a plurality of mobile objects 2. Accordingly, even if the transmission latency is large, early-stage monitoring as to whether the mobile object 2 is traveling along the target trajectory is ensured, thereby implementing smooth traveling of the mobile object 2. Although it is conceivable that each mobile object 2 generates a target trajectory, high efficiency and reduction in calculation load are expected by the trajectory generation unit 63 collectively generating the target trajectory.

Next, a method of setting a control gain by the gain setting unit 64b and a method of calculating a control amount by the control amount calculation unit 64c will be described with reference to FIG. 11 and Non-Patent Documents 1 to 3.

FIG. 11 is a block diagram illustrating an example of a configuration in which the remote control device 6 controls the mobile object 2 in the present embodiment. In FIG. 11, the solid lines mean the input/output of the signal represented by the continuous system, and the dashed line means the input/output of the signal represented by the discrete system.

The mobile object information of the mobile object 2 acquired by the sensor is a discrete value; therefore, the mobile object information corresponds to an output value of a sampler 6d. The mobile information is transmitted to the remote control device 6 via the network 1; therefore, transmission latency (upload transmission latency 6b here) occurs at this moment. The mobile object information is input to a control unit 6a with latency of this upload transmission latency. The control unit 6a outputs a control amount calculated using the control gain on the basis of the mobile object information. The control amount corresponds to the control amount output by the control amount calculation unit 64c. The control mount is transmitted to the mobile object 2 via the network 1; therefore, transmission latency (download transmission latency 6c here) occurs at this moment. The control amount to be input to the mobile object 2 at a certain time is kept a constant value by a holder 6e until the next input. That is, the holder 6e has a zero-order hold function. The control amount being zero-order hold is input to the mobile object 2.

A closed loop system is illustrated in FIG. 11; therefore, in order to secure control stability, it is required that the control gain is set in consideration of the transmission latency (upload transmission latency 6b and download transmission latency 6c), and the control amount is calculated. Control design utilizing the transmission latency being expressed using probability distributions will be described below. In this case, the control gain is set in consideration of the control stability regarding the probability distributions of the transmission latency, and the control amount is calculated.

A discrete-time state equation of the mobile object 2 is determined by a random variable as illustrated in the following Expression (1).

[Expression 1]

xₖ₊₁=Aₖ(ξₖ)zₖ+Bₖ(ξₖ)uₖ (1)

In Expression (1), k represents an integer greater than or equal to 0, xₖ represents a state quantity of mobile object 2 at time tₖ, uₖ represents an amount of control for mobile object 2, ξₖ represents a value of a random variable at time tₖ, and Bₖ(ξₖ) represent random matrices determined by ξₖ.

According to Non-Patent Documents 1 to 3, if there exist a and λ that satisfy the following Expression (2), for any positive integer k and any real vector x₀, the closed loop system is second-order moment exponentially stable, i.e. stable with respect to the probability distribution.

[Expression 2]

\sqrt{E[∥xₖ∥²]}≤α∥x₀∥λ^{k}tm(2)

In Expression (2), a represents a positive real number, ? represents a real number from 0 to 1, ∥xₖ∥ represents the Euclidean norm of the vector xₖ, and E represents the expected value of the random variable. Further, the control amount uₖ is expressed by the following Expression (3) using the control gain F.

[Expression 3]

uₖ=FXₖ (3)

At this point, the condition for the existence of the control gain F that satisfies the second-order moment exponential stability is existence of a positive definite matrix V, a real matrix W, and λ, that satisfy the following Expression (3).

$$\begin{matrix}[ Expression 4 ] & \\ [ \begin{matrix}{λ}^{2} V & {[ {H}_{A} V + {H}_{B} W ]}^{T} \\ {H}_{A} V + {H}_{B} W & V ⊗ I\end{matrix} ] > 0 & ( 4 )\end{matrix}$$

In Expression (4), T represents the transpose and I represents the identity matrix. H_{A} and H_{B} represent matrices defined by Expressions (5) to (7) below.

[Expression 5]

H_{A}=[H_{A1}^{T}, . . . ,H_{An}^{T}]T (5)

[Expression 6]

H_{B}=[H_{B1}^{T}, . . . ,H_{Bn}^{T}]^{T} (6)

[Expression 7]

H_{AB}=[H_{A1}, . . . ,H_{An},H_{B1}, . . . ,H_{Bn}] (7)

In Expressions (5) to (7), n is a natural number, H_{Ai} (i=1, . . . ,n) and H_{Bi} represent real matrixes. H_{AB} represents a real matrix that satisfies Expression (9) with respect to the matrix G_{AB} defined by Expression (8) below.

[Expression 8]

G_{AB}(ξ)=[row(Aₖ(ξ₀)),row(Bₖ(ξ₀))]^{T}·[row(Aₖ(ξ₀)),row(Bₖ(ξ₀))] (8)

[Expression 9]

H_{AB}^{T}G_{AB}=E[G_{AB}(ξ₀)] (9)

In Expression (8), row(Aₖ(ξ₀)) represents a row vector in which the elements of matrix Aₖ(ξ₀) are arranged in order from the first row.

If the closed loop system satisfies second-order moment exponential stability, the control gain F is given by the following Expression (10).

[Expression 10]

F=WV⁻¹ (10)

The control gain F and the control amount uₖ can be obtained from Expressions (3) and (10). In the above description, the closed loop system is represented by a stochastic system including the random variable, however, a control system represented by a deterministic system (hereinafter referred to as “deterministic system control”) can be fused with respect to this. In this case, the control gain F is set in consideration of not only the second-order moment exponential stability but also the stability of the deterministic system control. The deterministic system control includes known control system, such as H_{∞} control and H₂ control. Here, taking the H₂ control as an example, a method of setting the control gain F in the entire system will be introduced.

When considering control stability in a system, firstly, the stochastic system is replaced with the deterministic system. Then, the discrete-time state equation of the mobile object 2 is determined as illustrated in the following Expressions (11) and (12).

[Expression 11]

Xₖ₊₁=A(ξₑ)Xₖ≤B(ξₑ)uₖ (11)

[Expression 12]

Zₖ=Cxₖ+DWₖ (12)

In Expressions (11) and (12), ξₑ represents a value ξₖ of a certain random variable, which is a fixed value that does not change with time. ξₑ may be an average value or a median value obtained from the distribution of ξₖ represents an evaluation output at time tₖ, and wₖ represents a disturbance input at time tₖ. A(ξₑ), B(ξₑ), C and D represent time-invariant matrixes. Also, G(s) is assumed to represent the transfer function matrix from the disturbance input wₖ to the evaluation output zₖ. s represents the Laplacian operator. Also, D=0. In this case, the condition that the system requires is the real part of all eigenvalues of matrix A being negative, and ∥G∥(s)₂<α(α>0), which is the norm of G(s), being established. This condition is equivalent to the existence of a semi-positive definite matrix P and a positive definite matrix Z that satisfy the linear matrix inequalities of Expressions (13) to (15) below.

[Expression 13]

PA+A^{T}P+C^{T}C>0 (13)

[Expression 14]

Z−B^{T}PB>0 (14)

[Expression 15]

trace(Z)<a² (15)

In Expressions (15), trace(Z) represents the sum of the diagonal elements of the matrix Z. When H2 control is fused to the stochastic system, the control gain F is required to be set, in consideration of the second-order moment exponential stability of Expressions (2) and (4) and the linear matrix inequalities of Expressions (13) to (15). Although the H₂ control is taken as an example here, the same applies to the H_{∞} control. Accordingly, the gain setting unit 64b sets the control gain F in consideration of the control stability regarding the distribution of the transmission latency and a system performance condition expressed by linear matrix inequalities.

As for the stochastic system, the control gain F may be set in consideration of not only the probability distribution of transmission latency but also the probability distribution of coefficients with respect to the state quantity of the mobile object 2. In this case, the second-order moment exponential stability of Expressions (2) and (4) is applied to the probability distribution of transmission latency and the probability distribution of coefficients. Also, the gain setting unit 64b sets the control gain F in consideration of the control stability regarding the distribution of the transmission latency, the control stability regarding the distribution of coefficients, and a system performance condition expressed by linear matrix inequalities.

Note, there may be a case where no control gain F that satisfies the second-order moment exponential stability. In such a case, therefore, the control implementability determination unit 64d performs determination of control stop for the mobile object 2. In order to determine whether or not the closed loop system is second-order moment exponentially stable, the eigenvalues of the matrix on the left side of Expression (4) are calculated and whether or not the minimum eigenvalue is positive is determined. Alternatively, the control implementability determination unit 64d may perform the determination of control stop for the mobile object 2 when the absolute value of a difference between a cumulant of the distribution of the transmission latency estimated by mobile object estimation unit 64a and a cumulant of the distribution of the transmission latency when the control gain F is designed is greater than or equal to a specified value. Here, a cumulant is a value indicating characteristics of distribution. The cumulant may be a combination of the distribution of the transmission latency and the distribution of the coefficients for the state quantity of the mobile object 2. Alternatively, the control implementability determination unit 64d may perform the determination of control stop for the mobile object 2 when transmission latency greater than transmission latency with a predetermined probability occurs in the distribution of pre-estimated transmission latency. Alternatively, the control implementability determination unit 64d may perform the determination of control stop for the mobile object 2 when an error greater than a coefficient error with a predetermined probability occurs in the distribution of pre-estimated coefficients. As a result, the mobile object 2 can be normally controlled even when a problem arises in control stability.

When obtaining the control gain F and the control amount uₖ in the closed loop system including the probability distribution of the transmission latency, the discrete-time state equation of the mobile object 2 illustrated in Expression (1) is the starting point. However, the control gain F and the control amount uₖ are typically obtained with the continuous-time state equation of the mobile object 2 as a starting point. Accordingly, a method of obtaining the control gain F and the control amount uₖ on the basis of the continuous-time state equation will be described.

Then, the continuous-time state equation of the mobile object 2 is determined as illustrated in the following Expression (16).

[Expression 16]

\dot{x}_{c}=A_{c}x_{c}(t)+B_{c}u_{c}(t) (16)

In Expression (16), x_{c} represents the state quantity of the mobile object 2 in continuous time, u_{c} represents a control amount in continuous time, x_{c} represents a value obtained by time derivative x_{c}, and A_{c} and B_{c} represent matrixes. The continuous-time state equation of Expression (16) is converted into a discrete-time state equation according to the sampling interval hₖ (=tₖ+1−tₖ) at time tₖ. However, the sampling interval hₖ is determined not only by the transmission latency of the upload transmission latency 6b and the download transmission latency 6c, but also by the transmission latency when the signal transmission between each element in FIG. 11. The sampler 6d and the holder 6e transform Expression (16) into a discrete-time state equation as illustrated in Expression (17) below.

[Expression 17]

Xₖ₊₁=Aₖxₖ+Bₖuₖ₋₁ (17)

In Expression (17), Aₖ and Bₖ are given to Expressions (18) and (19) below.

[Expression 18]

Aₖ=e^{A}^{_{c}}^{h}^{ₖ} (18)

[Expression 19]

Bₖ=∫₀^{h}^{ₖ}e^{A}^{_{c}}^{t}B_{c}dt (19)

Since A_{K} and B K are represented using sampling interval hₖ in Expression (18) and Expression (19), a random matrix that depends on the value ξₖ of the probable variable. In Expression (17), an enlarged system in which new state quantity X_{0K}=U_{K-1} is added to Expression (17) since the control amount is not U_{K} but U_{K-1}. The enlarged system is expressed by following Expression (20).

[Expression 20]

x_{e,k+1}=Aₑx_{e,k}+Bₑuₖ (20)

In Expression (20), x_{e,k}, Aₑ and Bₑ, are expressed by Expressions (21) to (23).

$$\begin{matrix}[ Expression 21 ] & \\ {x}_{e} = [ \begin{matrix}{x}_{k} \\ {x}_{0 k}\end{matrix} ] … & ( 21 )\end{matrix}$$

$$\begin{matrix}[ Expression 22 ] & \\ {A}_{e} = [ \begin{matrix}{A}_{k} & {B}_{k} \\ O & 0\end{matrix} ] … & ( 22 )\end{matrix}$$

$$\begin{matrix}[ Expression 23 ] & \\ {B}_{e} = [ \begin{matrix}0 \\ J\end{matrix} ] … & ( 23 )\end{matrix}$$

Since Expression (20) has the same form as the discrete-state equation such as Expression (1), the control gain F and the control amount U_{K} in consideration of the secondary-order moment exponentially stable can be obtained using Expression (20).

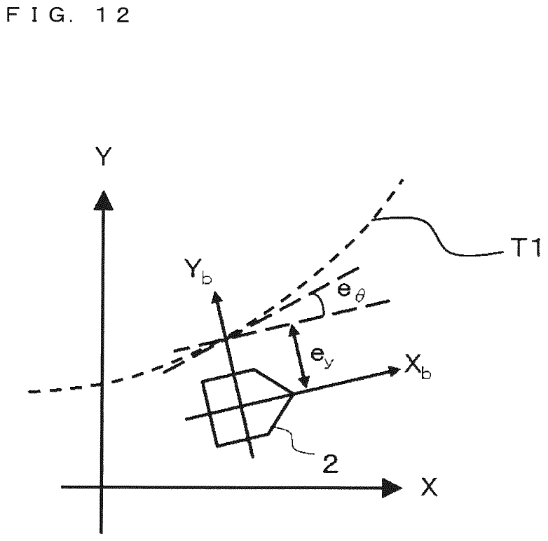

Next, when the mobile object 2 is a vehicle, a method of obtaining the control gain F and the control amount uₖ will be described. FIG. 12 is a schematic diagram illustrating an example of a vehicle model according to the present embodiment. In FIG. 12, the horizontal axis X and the vertical axis Y represent the position of the center of gravity of the vehicle in the inertial coordinate system. X_{b} and Y_{b} are the coordinate system based on the longitudinal and lateral directions of the vehicle. e_{y} and e_{θ} are, respectively, the lateral deviation and the angle of deviation of the vehicle relative to the target route T1. The continuous-time state equation for the lateral direction of the vehicle is expressed by Expression (24) below.

$$\begin{matrix}[ Expression 24 ] & \\ \frac{d}{dt} [ \begin{matrix}{e}_{y} \\ {\dot{e}}_{y} \\ {e}_{θ} \\ {\dot{e}}_{θ}\end{matrix} ] = [ \begin{matrix}0 & 1 & 0 & 0 \\ 0 & - \frac{2 {C}_{f} + 2 {C}_{r}}{{mv}_{x}} & \frac{2 {C}_{f} + 2 {C}_{r}}{{mv}_{x}} & - \frac{2 {C}_{f} {L}_{f} + 2 {C}_{r} {L}_{r}}{{mv}_{x}} \\ 0 & 0 & 0 & 1 \\ 0 & - \frac{2 {C}_{f} {L}_{f} - 2 {C}_{r} {L}_{r}}{{I}_{2} {v}_{x}} & \frac{2 {C}_{f} {L}_{f} - 2 {C}_{r} {L}_{r}}{{I}_{2}} & - \frac{2 {C}_{f} {L}_{f}^{2} + 2 {C}_{r} {L}_{r}^{2}}{{I}_{2} {v}_{x}}\end{matrix} ] [ \begin{matrix}{e}_{y} \\ {\dot{e}}_{y} \\ {e}_{θ} \\ {\dot{e}}_{θ}\end{matrix} ] + [ \begin{matrix}0 \\ \frac{2 {C}_{f}}{m} \\ 0 \\ \frac{2 {C}_{f} {l}_{f}}{{I}_{2}}\end{matrix} ] δ & ( 24 )\end{matrix}$$

In Expression (24), vₓ represents a vehicle speed, δ represents a steering angle, m represents a mass, L_{f} represents a distance from the vehicle center of gravity to the front wheel 2v, Lᵣ represents a distance from the center of gravity of the vehicle to the rear wheel 2w, I_{z} represents the moment of inertia around the yaw axis, C_{f} represents the cornering stiffness of the front wheels 2v, and Cᵣ represents the cornering stiffness of the rear wheels 2w. Cornering stiffness is a proportional coefficient representing the relationship between the lateral force generated in the vehicle and the sideslip angle, and is a value that varies depending on road conditions (dry, wet, frozen, etc.), for example.

From Expression (24), the vehicle can follow the target route in the lateral direction by controlling e_{y}, e_{θ}, e_{y}, and e_{θ} to be zero. Further, the continuous-time state equation for the longitudinal direction of the vehicle is expressed by Expression (25) below.

$$\begin{matrix}[ Expression 25 ] & \\ \frac{d}{d t} [ \begin{matrix}{v}_{x} \\ {a}_{x}\end{matrix} ] = [ \begin{matrix}0 & 1 \\ 0 & - \frac{1}{{T}_{a}}\end{matrix} ] [ \begin{matrix}{v}_{x} \\ {a}_{x}\end{matrix} ] + [ \begin{matrix}0 \\ \frac{1}{{T}_{a}}\end{matrix} ] {u}_{a} & ( 25 )\end{matrix}$$

In Expression (25), aₓ represents a longitudinal acceleration, uₐ represents a target acceleration in the longitudinal direction, and T a represents the time constant of the first-order lag system. Expression (25) corresponds to the continuous-time state equation of Expression (16). Expression (25) is converted into a discrete-time state equation according to the sampling interval hₖ that is affected by the transmission latency of the network 1. Then, the control gain F that minimizes the evaluation function represented by the vehicle speed vₓ, the longitudinal acceleration aₓ, and the target acceleration uₐ is determined while taking into consideration of the second-order moment exponential stability of Expressions (2) and (4). In other words, the control gain F is obtained in consideration of the transmission latency with Expression (25) as a regulator problem. At this point, not only the distribution of the transmission latency but also the distribution of the coefficients with respect to a vehicle state quantity may be considered. Also, the H₂ control or the H_{∞} control may be combined and a condition regarding the control stability thereof may be added.

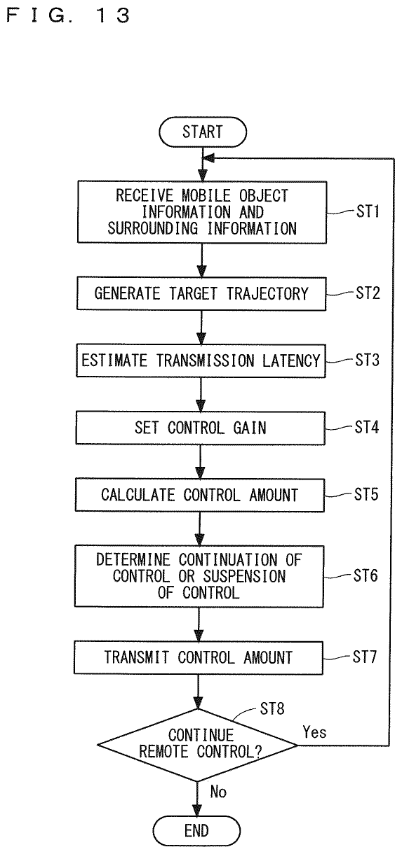

FIG. 13 is a flowchart illustrating an example of a procedure for remote control according to the present embodiment.

As illustrated in FIG. 13, when the remote control of the mobile object 2 starts by a means (not illustrated), the receiver 62 receives mobile object information and surrounding information (Step ST1).

The trajectory generation unit 63 generates a target trajectory on the basis of the map data from the map database 7 and the surrounding information from the receiver 62 (Step ST2).

The mobile object estimation unit 64a estimates the transmission latency (Step ST3). The mobile object estimation unit 64a may estimate the distribution of the transmission latency, or may estimate the distribution of the coefficients for the state quantity of the mobile object 2.

The gain setting unit 64b sets a control gain on the basis of the transmission latency of the network 1 (Step ST4). The gain setting unit 64b may set the control gain on the basis of the distribution of the transmission latency or may set the control gain on the basis of the distribution of the transmission latency and the distribution of the coefficients for the state quantity of the mobile object 2.

The control amount calculation unit 64c calculates a control amount on the basis of the mobile object information from the receiver 62 and the control gain (Step ST5).

The control implementability determination unit 64d determines continuation of control or suspension of control on the basis of the transmission latency from the mobile object estimation unit 64a (Step ST6). The control implementability determination unit 64d may perform the determination on the basis of the distribution of the transmission latency, or may perform the determination on the basis of the distribution of the transmission latency and the distribution of the coefficients for the state quantity of the mobile object 2. When the determination result is suspension of control, the control implementability determination unit 64d sets a value that causes the mobile object 2 to stop as the control amount.

The transmitter 65 outputs the control amount from the control implementability determination unit 64d to the mobile object 2 (Step ST7).

An unillustrated means determines whether or not to continue the remote control (Step ST8).

When the determination in Step ST8 is “Yes”, the process returns to Step ST1 to continue remote control. When the determination in Step ST8 is “No”, the remote control ends.

According to the embodiment described above, smooth traveling can be implemented since the remote control device 6 generates the target trajectory of the mobile object 2.

Here, a hardware configuration of the remote control device 6 in the present embodiment will be described. Each function of the remote control device 6 may be implemented by a processing circuit. The processing circuit includes at least one processor and at least one memory.

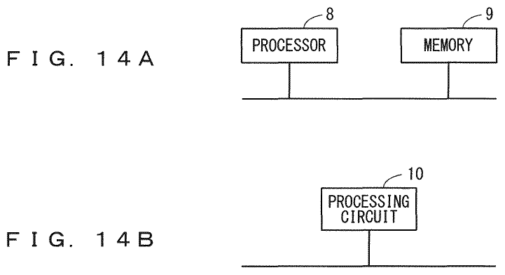

FIG. 14 is a diagram illustrating the hardware configuration of the remote control device 6 according to the present embodiment. The remote control device 6 can be implemented by a processor 8 and a memory 9 illustrated in FIG. 14(a). The processor 8 is, for example, a Central Processing Unit (also referred to as CPU, central processing unit, processor, arithmetic unit, microprocessor, microcomputer, processor, Digital Signal Processor (DSP)) or system Large Scale Integration (LSI).

The memory 9 is, for example, a non-volatile or volatile semiconductor memory, such as a Random Access Memory (RAM), a Read Only Memory (ROM), a flash memory, an Erasable Programmable Read Only Memory (EPROM), an Electrically Erasable Programmable Read Only Memory (EEPROM (registered trademark)), or the like, a Hard Disk Drive (HDD), a magnetic disk, a flexible disk, an optical disk, a compact disk, a mini disk, a digital versatile disc (DVD) or the like.

The function of each unit of the remote control device 6 is implemented by software (software, firmware, or software and firmware). Software etc. is written as a program and stored in the memory 9. The processor 8 reads out and executes the program stored in the memory 9, thereby implementing the function of each unit. In other words, it can be said that the program causes a computer to execute the procedure or the method of the remote control device 6.

The program executed by the processor 8 may be stored in a computer-readable storage medium in an installable or executable format and provided as a computer program product. Also, the program executed by processor 8 may be provided to the remote control device 6 via a network such as the Internet.

Also, the remote control device 6 may be implemented by a dedicated processing circuit 10 illustrated in FIG. 14(b). When dedicated hardware is applied to the processing circuit 10, the processing circuit 10 corresponds, for example, to a single circuit, a composite circuit, a programmed processor, a parallel programmed processor, an Application Specific Integrated Circuit (ASIC), or a Field-Programmable Gate Array (FPGA), or the combination thereof.

The configuration in which the functions of the components of the remote control device 6 are implemented by any one of software or the like and hardware has been described above. However, the configuration is not limited thereto, a configuration in which some components of the remote control device 6 are implemented by software or the like and some other components are implemented by dedicated hardware may be adoptable.

### EXPLANATION OF REFERENCE SIGNS

1 network, 2 mobile object, 21 first mobile object, 22 second mobile object, 2a clock synchronization unit, 2b internal sensor, 21 vehicle speed sensor, 22b IMU sensor, 23b steering angle sensor, 24b steering torque sensor, 2c transmitter, 2d receiver, 2e command value calculation unit, 2f actuator, 2g steering wheel, 2h steering shaft, 2i electric motor, 2j rack-and-pinion mechanism, 2k tie rod, 2m front knuckle, 2n vehicle drive device, 2o shaft, 2p brake control device, 2r brake, 2t pinion shaft, 2u rack shaft, 2v front wheel, 2w rear wheel, 4 object information acquisition unit, 40 obstacle, 41 clock synchronization unit, 42, 43 sensor, 5 environment information acquisition unit, 50a stop line, 50b traffic light, 5l clock synchronization unit, 52 sensor, 6 remote control device, 61 clock synchronization unit, 62 receiver, 63 trajectory generation unit, 64 mobile object control calculation unit, 641 first mobile object control calculation unit, 642 second mobile object control calculation unit, 64a mobile object estimation unit, 64b gain setting unit, 64c control amount calculation unit, 64d control implementability determination unit, 64e state quantity estimation unit, 65 transmitter, 6a control unit, 6b upload transmission latency, 6c download transmission latency, 6d sampler, 6e holder, 7 map database, 8 processor, 9 memory, 10 processing circuit, S1 travelable area, T1 target route, T11 target route for the first mobile object, T12 target route for the second mobile object, R42 detection range of the sensor 42, R43 detection range of the sensor 43, R52 detection range of the sensor 52.

1. A remote control device configured to control one or more mobile objects via a network, comprising:
a processor to execute a program; and
a memory to store the program which, when executed by the processor, performs processes of,
receiving mobile object information including a first state quantity of a state quantity of the mobile object and surrounding information around the mobile object;
generating a target trajectory of the mobile object on the basis of the surrounding information;
estimating a probability distribution of transmission latency of the network;
setting a control gain on the basis of the probability distribution of the transmission latency;
calculating a control amount for causing the mobile object to follow the target trajectory on the basis of the mobile object information and the control gain; and
transmitting the control amount to the mobile object.

2. The remote control device according to claim 1, wherein
a second state quantity different from the first state quantity of the state quantity is estimated on the basis of the mobile object information, and
the control amount is calculated on the basis of the mobile object information, the second state quantity, and the control gain.

3. The remote control device according to claim 1, wherein
a value that causes the mobile object to stop is set as the control amount when determining continuation of control or suspension of control of the mobile object on the basis of the probability distribution of the transmission latency and a determination result is the suspension of control.

4. The remote control device according to claim 1, wherein
a probability distribution of the transmission latency, and a distribution of mass of the mobile object or moment of inertia are estimated, and
the control gain is set on the basis of the probability distribution of the transmission latency, and the distribution of the mass of the mobile object or moment of inertia.

5. The remote control device according to claim 3, wherein
a probability distribution of the transmission latency, and a distribution of the mass of the mobile object or moment of inertia are estimated,
the control gain is set on the basis of the probability distribution of the transmission latency, and the distribution of the mass of the mobile object or moment of inertia, and
continuation of control or suspension of control is determined on the basis of the probability distribution of the transmission latency, and the distribution of the mass of the mobile object or moment of inertia.

6.-7. (canceled)

8. The remote control device according to claim 1, wherein
the control gain is set in consideration of control stability regarding the probability distribution of the transmission latency.

9. The remote control device according to claim 4, wherein
the control gain is set in consideration of the control stability regarding the probability distribution of the transmission latency, and the distribution of the mass of the mobile object or moment of inertia.

10. The remote control device according to claim 8, wherein
the control gain is set in consideration of the control stability and a system performance condition expressed by linear matrix inequalities.

11. The remote control device according to claim 1, wherein
the target trajectory is an avoidance trajectory with respect to an obstacle and a stopping trajectory until the mobile object stops.

12. The remote control device according to claim 1, wherein
two or more of the mobile objects exist, and
the target trajectory for each of two or more of the mobile object is generated on the basis of the surrounding information.

13. The remote control device according to claim 12, wherein
the target trajectory in which travel priorities of the mobile objects are considered is generated.

14. The remote control device according to claim 12, wherein
the target trajectory in which, with respect to the mobile object, which is a leader of the mobile objects, the mobile object other than the leader forms a column is generated.
